(19) United States
(12) Patent Application Publication
(10) Pub. No.: US 2009/0276655 A1
(43) Pub. Date: Nov. 5, 2009

(54) Method for detecting errors during initialization of an electronic appliance and apparatus therefor

(75) Inventors: Thierry Quere, Monfort Sur Meu (FR); Louis-Xavier Carbonnel, Pace (FR); Jean-Claude Colmagro, Mouaze (FR)

Correspondence Address: Thomson Licensing LLC, P.O. Box 5312, Two Independence Way, PRINCETON, NJ, 08543-5312, US

(73) Assignee: Thomson Licensing LLC

(21) Appl. No.: 11/988,620

(22) PCT Filed: Jul. 7, 2006
(86) PCT No.: PCT/EP2006/064024

§ 371 Date: Jul. 2, 2009

(30) Foreign Application Priority Data
Jul. 11, 2005 (FR) 0552135

(51) Int. Cl. G06F 11/14

(52) U.S. Cl. 714/2; 714/48; 714/E11.113

(57) ABSTRACT

The invention concerns a method for detecting problems arising during the launching phase of a resident software of an electronic appliance to be detected. Said detection is carried out by means of data written in the non-volatile memory during said phase. Said data are then erased in case of success. In case of failure, it is then possible, upon the next restart, to use said data to detect the problem.

### 1. SCOPE OF THE INVENTION

The present invention relates to the domain of electronic device initialisation and, more precisely, the detection of problems arising during the initialisation phases of an operating system embedded in the device.

### 2. TECHNOLOGICAL BACKGROUND

The initialisation schema of an electronic device with an operating system is generally as follows.

In a first phase, a system kernel is loaded into memory and executed. This kernel is generally designed to be minimal. It offers minimal, basic functions such as memory manager and task scheduler. This kernel is usually designed statically such that its initialisation and launch are reproducible. Hence, unless there is a hardware malfunction, kernel initialisation is sure to be successful.

In a second phase, a certain number of services are launched. These services provide the system's more elaborate functionalities. They are supported by the kernel. These services provide, for example, management of peripherals, any necessary management of the device's layers of communication with the outside world, input/output peripherals, network or other. These services can also comprise the management of user preferences as well as the recovery of configuration parameters saved during a previous use of the device as well as any service in relation to the particular purpose of the device.

The complexity of these services and the recognition of the user and environmental parameters of the device make it much more difficult to guarantee the success of this phase. Indeed, all scenarios cannot be tested and errors can still occur.

In a third phase, once all the services that make up the system are launched, an application is also launched. This is the application that will finalise the functionalities of the device in its environment. This application is launched on a complete, operational operating system. The system generally allows errors arising in the application to be corrected. Quite often, re-launching the application is sufficient.

We can therefore see that the most critical errors are those arising during the second phase, the service launch phase. Methods exist to attempt to deal with these errors. For example, in the world of personal computers, systems generally offer several launch modes including an “error-free” mode that consists of launching a minimum system. This minimum system does not generally attempt to initialise the services, and offers the user an interface to correct the launch parameters of these services. In this manner, when confronted with an initialisation error, the user is able to correct the cause of this error and recover a usable device. This correction can go as far as the complete replacement of the system. This method functions correctly in the world of computers, but requires certain skills from the user as well as indulgence with regards to such problems.

However, in the domain of “general public” electronics, applying equivalent methods is not considered. Moreover, the user of a general public device is not willing to easily accept the malfunctions of the device. Indeed, he is accustomed to devices with a lower level of complexity that are generally free from malfunctioning. Also, such a user cannot be required to possess the skills necessary to correct potential problems “manually”.

A first measure enabling errors to be corrected is the ability to update the system. This possibility exists for many devices. For example, devices that can be connected to a personal computer can often be updated by system versions from this computer. Digital television reception devices can also generally be updated through the reception of new versions of the system software. This method allows the design errors of the system or the corruption of the memory dump of this system to be overcome, or new functionalities to be added. The decision to start the download operation is generally taken only when a certain number of criteria have been met. Among these criteria are the presence of a new resident software version or the detection of a corrupted version of the present software in the device.

The document U.S. Pat. No. 6,393,585 seems to diclose the launch of a terminal according to such a method. According to this document, users load and launch a first application during startup, and if a problem arises they load another application. Such a method does not allow startup problems to be treated delicately.

Another measure for treating errors in general public devices is the additional possibility of restarting the device. This restarting operation can be automatic or controlled by a specific action by the user. This restarting measure allows the system to be re-launched and allows errors arising during the use of the device to be dealt with.

It is therefore possible that the criteria to trigger the download of new software versions will not be met, but that the initialisation phase of the system services leads to a problem. In this case, the problem provokes a system restart. A series of restarts all leading to an error then occur, and therefore leading to a new restart.

### 3. SUMMARY OF THE INVENTION

The invention allows problems arising during the launch phase of the resident software of an electronic device to be detected, the launch phase being divided into several steps or modules. This detection is done using information that is written to the non-volatile memory during this phase and before the launch of each module. This information is subsequently deleted in the case of success. In the event of failure, it is therefore possible, during the next restart, to use this information to detect the problem and the associated module. Users therefore benefit from high precision in the detection of a problem that can arise during startup.

The invention relates to a method to detect errors arising during the startup of an electronic device comprising the permanent memory, this device being driven by a resident software, the method comprising at least the following steps:
at least one step for writing information to the device memory during a first startup,
during a second startup, a step to detect an error that arose during the first startup, according to the said information written to the memory during this first startup.

Advantageously, the startup process involves the successive launch of a plurality of modules and comprises a step for writing information to the memory before each module is launched.

According to a particular embodiment, the method also comprises a step to delete the information written to the memory upon completion of an error-free launch of at least one part of the resident software.

According to a particular embodiment, the error-detection step is done by detecting the presence of the said information written to the memory during the startup process.

According to a particular embodiment, the method also comprises the trigger of an alert following the detection of at least one previous startup having generated an error.

According to a particular embodiment, the method also comprises a step to restore the default value of at least one parameter of the device when an alarm is triggered.

According to a particular embodiment, the method also comprises a step to deactivate the launch of at least one module during the following startup of the device when an alarm is triggered.

According to a particular embodiment, the method also comprises a step causing a download of a new version of resident software when an alarm is triggered.

According to a particular embodiment, the method also comprises a step causing the display of information for the user when an alarm is triggered.

The invention also relates to an electronic device comprising permanent memory, a resident software designed to control it, resident software launch means upon startup of the device also comprising means to write information to the device memory before the launch of each module during the startup process that comprises the successive launch of a plurality of modules and means to detect an error arising during the previous startup according to the said information written to the memory during the startup process.

According to a particular embodiment, the device also comprises means to delete the information written to the memory on completion of an error-free launch of at least one part of the resident software.

According to a particular embodiment, the device also comprises the means to trigger an alarm following the detection of at least one previous startup having generated an error.

According to a particular embodiment, the device also comprises means to reset the default value of at least one parameter of the device when an alarm is triggered.

According to a particular embodiment, the device also comprises means to deactivate the launch of at least one module during the following device startup when an alarm is triggered.

According to a particular embodiment, the device also comprises means to cause a download of a new version of resident software when an alarm is triggered.

According to a particular embodiment, the device also comprises means to display information for the user when an alarm is triggered.

### 4. DESCRIPTION OF THE FIGURES

The invention will be better understood, and other specific features and advantages will emerge from reading the following description, the description making reference to the annexed drawings wherein:

FIG. 1 illustrates a flowchart of the method according to the embodiment of the invention.

FIG. 2 illustrates an embodiment of a device according to the invention.

### 5. DETAILED DESCRIPTION OF THE INVENTION

The embodiment of the invention that will now be described falls is found in the domain of digital television decoders, but is not limited to this domain. These decoders are responsible for receiving and decoding broadcasted television services. Such services can be broadcast with several kinds of technology, for example satellite, cable, terrestrial, and more recently computer networks like the Internet. These services are generally broadcast in the form of streams of digital data where several services may be combined, and where the different components of each service are combined. These components can comprise audio components, video components, and information on the service. Information for displaying an electronic programming guide, interactive applications, and other kinds of information can also be found in the stream. Some of these components can be compressed and the services are generally encoded in such a way that they can only be used by the persons authorised to view them. Viewing such services requires the use of a decoder device, which can receive the broadcast digital stream, separate, decode, decompress, and synchronise the different components with the aim of recovering them on, for example, a television set. The decoder must also be able to receive, store, and display data and related programmes such as the programme guide, and applications such as games or other.

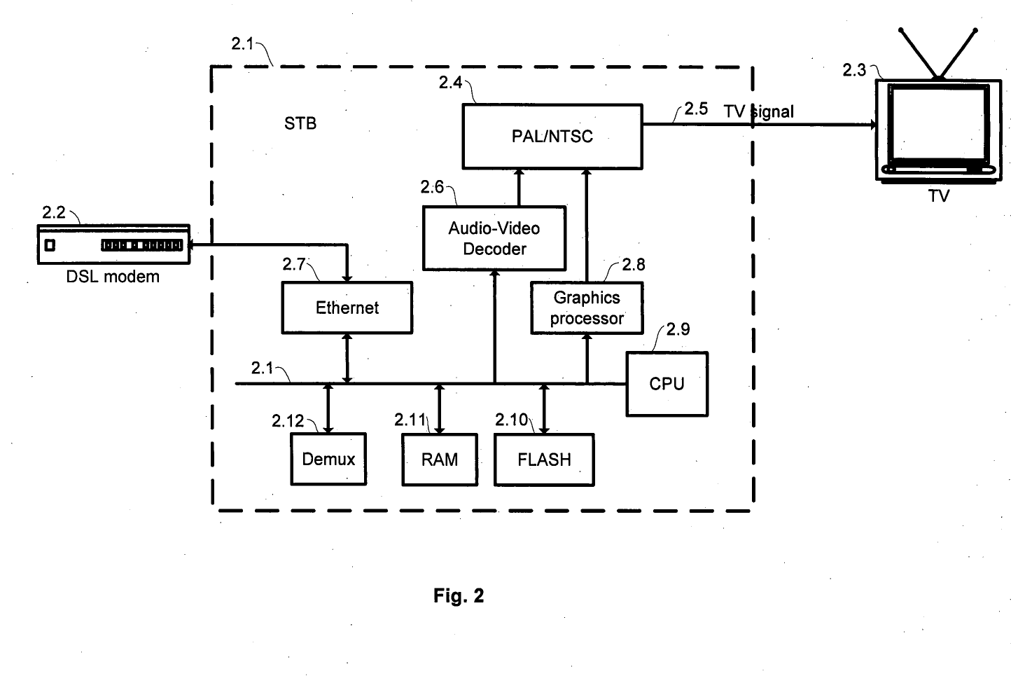

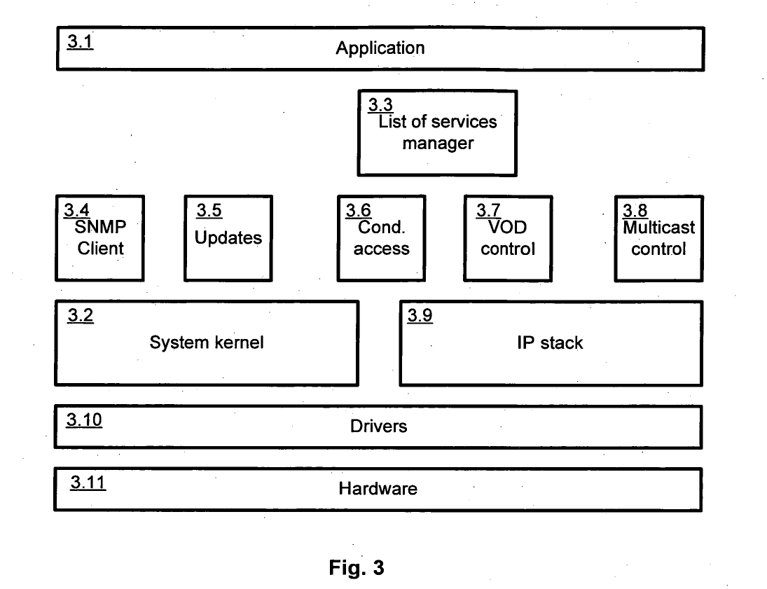

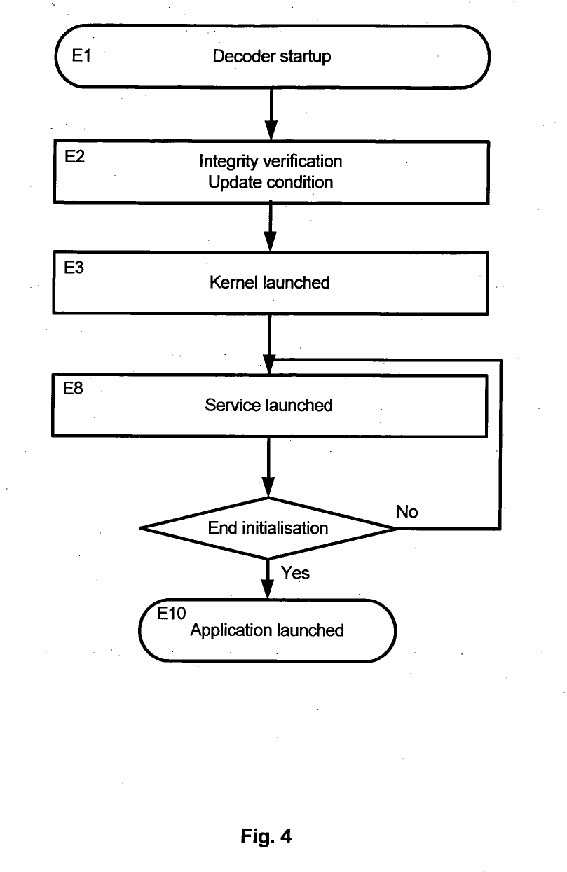

An example of the architecture of such a device is illustrated in FIG. 2. The decoder itself is outlined in box 2.1. The decoder given as an example is a decoder that receives services via a computer network like the Internet. It is therefore connected via an Ethernet interface labelled 2.7 to a modem, for example DSL (Digital Subscriber Line) labelled 2.2 providing the connection by using the telephone lines. The stream of data received will be demultiplexed by the demux labelled 2.12 after having passed through the bus 2.1 under the control of processor 2.9. The audio and video components are then decoded and/or decompressed by decoder labelled 2.6. Any additional data such as menus will be processed by the graphics processor labelled 2.8. The data from decoder 2.6 and graphics processor 2.8 will be converted into audio and video signals by the digital-analogue converter labelled 2.4. These signals labelled 2.5 are produced in accordance with a television standard such as PAL or NTSC, for a display on a television set labelled 2.3. The decoder is controlled by the processor 2.9. This processor runs an operating system stored in FLASH memory labelled 2.10. This FLASH memory has the property of being permanent, the information stored there is therefore kept in memory when the power supply of the device is switched off. This system uses the RAM (Random Access Memory) as working memory.

This type of device generally operates under the control of a software layer, an example of whose architecture is given in FIG. 3. In this figure, the decoder's hardware is represented by the box 3.11. An first driver layer, labelled 3.10, enables this hardware to be managed. A system kernel, labelled 3.2, implements basic system mechanisms like the task manager and scheduler. Communication between the decoder and the IP network is managed by an IP stack, labelled 3.9. A certain number of modules are implemented above the system kernel, some of which are implemented above the IP communication layer. Among these modules one can find, in a non-exhaustive manner, an SNMP (Simple Network Management Protocol) client labelled 3.4, being used to allow a set of decoders to be managed from a central console. An update manager, labelled 3.5, can also be found, enabling the management of resident software updates by downloading new software parts. In addition, a conditional access module, labelled 3.6, can be found being used to check that the user is indeed authorised to view the streams received for example in the context of paying television offers. A Video on Demand (VOD) module labelled 3.7 allows the access to on-demand broadcast content to be controlled. A multicast broadcast control module labelled 3.8 is responsible for managing the reception in this mode of streams containing the television services. A control module of the list of services, labelled 3.3, is responsible for recovering and maintaining the list of services to which it has the right to use.

These modules therefore provide a series of services, these services using the functionalities of the system kernel in the sense that they are generally launched as tasks managed and scheduled by the kernel. According to their needs, they make use of the IP communication layer or hardware drivers. For example, the access control module will use the chip-card reader module driver.

Overall, the device is managed by an application, labelled 3.1, whose purpose is to provide the user with the operating interface of his device. This application will therefore provide a set of functionalities such as the display, via the connected television set, of the list of available programmes, the possibility of choosing one of the programmes, and the reception of the said programme by the decoder. To operate, each of these functionalities will use the services of the modules and of the system launched on the device.

This set of resident software, comprising the drivers, the kernel, the modules, and the application, is stored in flash memory. When the device is started up, the software must generally be loaded into RAM and launched in the sequence illustrated in FIG. 4. In the first step, labelled E1, the decoder starts up. Then, in a second step (labelled E2), the integrity of the image of the resident software, kernel, drivers, service modules, and application is verified. Indeed, for corruptions of software stored in flash memory, or any other kind of permanent memory, it is traditional to include a system to verify the integrity of this software and to download an integral replacement version in the event of corruption. This system can operate on the basis of CRC (Cyclic Redundancy Code), adding a code calculated from the integrality of the software in memory. At an early stage of the system launch, before the launch of any portion of saved code, a CRC calculation is made on the code and compared to the saved code. In the event of a discrepancy, a corruption is detected and a replacement version is downloaded. This CRC protection can be applied to the entire software or by code module. In this way, it will never tempted to launch a corrupt code. This step E2 also checks that a system update is not required, even in the case of system integrity. Indeed, in certain cases, for example the availability of a new version of resident software for the decoder, or for any other reason, the application can request the downloading of a new resident software. Generally this is done through placement of a download flag in a known area of the memory, along with additional necessary information like an identifier of the required software version. When the update conditions have been met, non-integrity or download request, a resident software version is downloaded and placed in memory as a replacement for the existing version. At the end of this step, the device is certain to possess an integral version of the resident software. Software is said to be integral when each byte that makes up the copy of the software stored in memory matches the corresponding byte in the reference version. This means that no process, physical or software, has modified the value or corrupted any of these bytes.

Then, in the second step (labelled E3), the system kernel is loaded into the memory and launched. Next, after the drivers have been launched in a step not shown in the illustration, services are loaded and launched by the system kernel. These services are launched one after the other as shown in step E8, which is repeated until all the services have been launched. Once all services are launched, the application is launched in step E10. The decoder is then operational and ready for use.

The software launch can therefore be broken down into three phases corresponding to the kernel launch, the launch of the services, and the launch of the application. Each of these phases is subject to execution problems. Depending on the different characteristics of each of these phases, the type of error, their probability of occurring, their consequences on the operation of the system, as well as the foreseeable corrective measures are different.

The kernel launch phase is characterised by minimal software that will be executed on the hardware. This software does not generally take parameters into account, or a limited number of external parameters. It is therefore generally possible to exhaustively test the operation of the kernel. We have a software whose operation remains relatively simple and is executed in a stable environment. The probability of an error occurring at this point is therefore low and generally due to hardware failure or to corruption of the version stored in flash memory.

The service launch phase is, for its part, characterized by more complex functionalities, which means that its software is more difficult to test in an exhaustive manner. In addition, many of these modules use external parameters when they are launched. For example, the access control module that uses information contained in the chip card can be cited, the list of services controller may search for a list of services on the network or may initialise with a list saved from previous use. It will also be common for a module to use the user parameters also saved from previous use. Service software modules are therefore relatively complex programmes that run in a changing environment. As a result, thoroughly testing them in relation to all possible parameter values is generally impossible. They can also be victims of hardware failure or corruption of the software saved in memory.

As for the application launch phase, it is characterized as being a more complex service launch phase with execution conditions that change even more. Indeed, its execution, in addition to the different parameters that it must take into account, must also interact with the user and all the actions that the user can take regarding the decoder. It can also experience hardware failure or corruption of its software saved in memory.

The different measures that can be adopted to try to manage errors better will now be described.

As for hardware failure, there is generally nothing to be done, as the user must take the device in for repair.

It has been observed that the kernel was mainly suffering from errors due to hardware failures and the corruption of its saved software image. No other error recovery mechanism is generally planned for this code.

As for the application, it generally also has a mechanism to detect blockages due to software problems arising during execution. This mechanism, known as a watchdog reset, consists, for the system, of initialising a counter decreasing to 0. The application regularly increases the watchdog reset counter in such a way that it never reaches 0. When the application freezes, it is no longer able to increase the counter, which therefore reaches the zero value. When the counter reaches the value 0, the system triggers a system re-initialisation, a restart of the decoder. This restart is generally sufficient to re-establish the operational status of the device. Since problems arising during the operating phase of the application are generally due to its use or to the occurrence of external conditions, the restart results in a new launch in which the conditions responsible for the problem have disappeared.

The service launch phase, beyond the corruption of the software in memory and hardware failures, can experience launch problems. Indeed, these services have a certain complexity and, in addition, their launch can depend on external parameters such as the last list of services or user preferences. These modules cannot be thoroughly tested with all of the possible external parameter values. As a result, blockages can occur during the launch. These problems cannot generally be resolved by restarting the device, this restart not changing the parameters taken into account. Parameters causing a module execution error, doing so each time. In such a situation, a device being started up may experience an error when a module is launched. This error then causes the device to be restarted. The error reoccurs at restart and the device enters an unbreakable cycle of restarts.

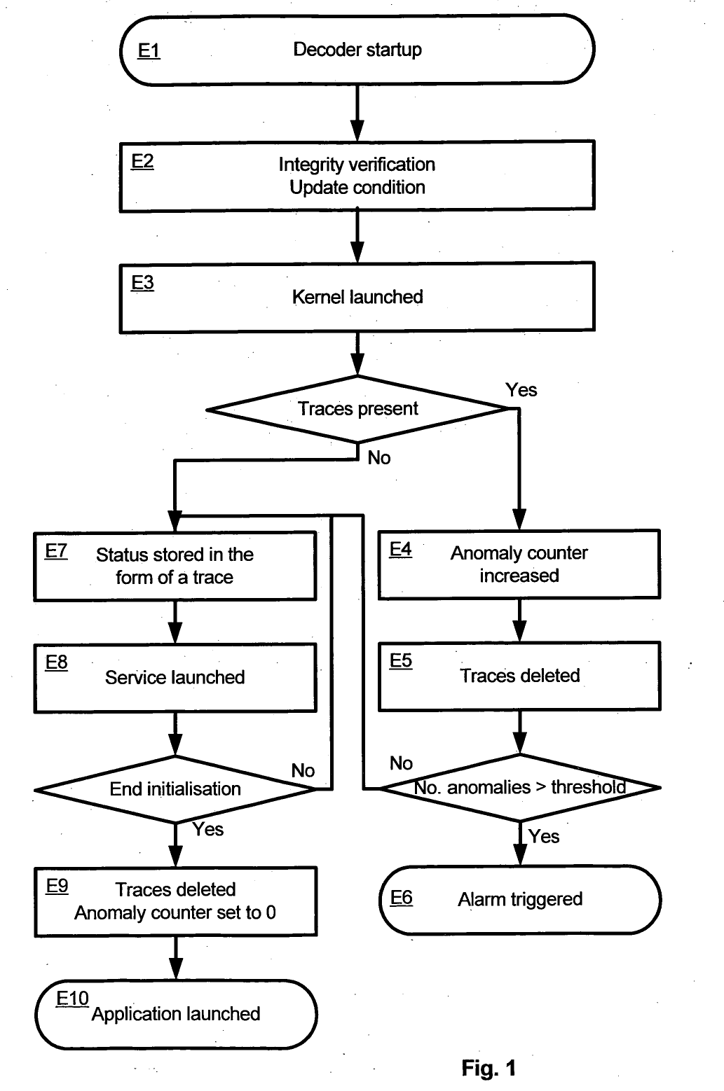

FIG. 1 presents a startup diagram according to an embodiment of the invention allowing this type of situation to be detected and corrective measures to be taken. The embodiment is based on the fact of memorising switching points during the service launch phase. This memorisation is done by writing “trace” data to memory. These traces are deleted from the memory at the end of the service startup phase when this startup was successful. However, when problems arise during the launch of one of the services, a restart occurs before reaching the stage when these traces are deleted. During this startup, the presence of traces in the memory indicates that the previous startup was not completed. Moreover, the value of the trace allows the service that caused the problem to be identified. In step E1, the device is started up. A step E2 of verifying the integrity of the software of the device follows and of downloading, if necessary, a new resident software. Next follows the step E3 of launching the kernel and the drivers. At the end of this step E3, the presence of traces written to memory is checked. If no traces are present, the previous startup was successful, and the service launch process can be begun. This information is memorised in the form of a first trace in step E7. The first service is then launched by a step labelled E8. Next, steps E7 and E8 are repeated, by storing the status of the service launch process each time in step E7. This status can be, for example, a reference to the last service launched or to the next one that will be launched. When all the services have been launched, traces are deleted in a step E9. This step will, in the embodiment, also reset an anomaly counter that will be described below. Next, the services having been launched successfully, an application launch step E10 ends the device startup process.

When the launch of a service fails, the device restarts either immediately or at the command of the user after the device blocks. In any case, this restart occurs before startup process can carry out the step E9 of trace deletion. Hence, during the restart, the trace presence test carried out at the end of the kernel launch step E3 will be positive. In this case, a step E4 consists of increasing an anomaly counter. This counter is used to count the number of successive failed startups. The traces will then be deleted in a step E5. The order of these two steps is not important. A test will then be performed to test the anomaly counter in relation to a threshold. If this threshold is exceeded, an alarm will be triggered to allow corrective actions to be taken. The use of this anomaly counter associated with the threshold test allows an alarm to be triggered only after a certain number of successive failed startups generate an error. This use is optional; indeed, it is possible to trigger the alarm from the first failed startup. But in this case, it is possible to trigger alarms when the problem arises from, for example, an accidental interruption in the startup process such as a power outage or the device being turned off by the user. As long as this threshold is not reached, the startup will be attempted through the execution of steps E7 to E10. The threshold will typically be a few units, 3 or 5. The higher the value, the more failed startups will be necessary to trigger the alarm; the lower the value, the higher the risk of triggering an alarm for an accidental problem.

Several kinds of corrective actions are possible. The first possibility is to reset the device to a default configuration. In other words, all the parameters, such as the user profile, his preferences, list of services, are reset to the default values. In this manner a known and tested configuration is obtained that allows startup to take place. The faulty service launch can also be deactivated and the device can be restarted short of one or more services. This will probably lead to a degraded functionality but can allow the user to correct the problem. A request to download a new version of resident software can also be written to memory to reset the device to a known state. It is possible to display a message for the user. It is also possible to implement a strategy of recovery where the parameters will initially be reset to default values, then if that is not sufficient, some services can be deactivated so that, in case these actions fail, a new version of the resident software can be requested for download. Preferably, the user will be made aware of the situation by on-screen messages or by other means of communication such as the activation of specific signals on the device.

The embodiment thus described is not restrictive. Those skilled in the art understand that adaptations are possible. In particular, deleting traces can be replaced by writing a parameter indicating that the last startup was successful, parameter that will be initialised at a value indicating a problem before the service launch phase. It is also obvious that corrective actions can be combined in multiple ways without leaving the framework of the invention. It is also possible to choose differently the moment and content of the traces written to memory.

1. Method for detecting errors arising during the startup of an electronic device comprising permanent memory, this device being controlled by a resident software, wherein the resident software startup process comprises at least the following steps:
during an initial startup, at least one step to write information to the device's memory before each module is launched, the startup process involving the successive launch of a plurality of modules,
during a second startup, a step to detect an error that arose during the first startup, according to the said information written to the memory during this first startup.

2. Method according to claim 1 also comprising a step to delete the information written to the memory on completion of an error-free launch of at least one part of the resident software.

3. Method according to claim 2 wherein the error-detection step is done by detecting the presence of said information written to the memory during the startup process.

4. Method according to claim 1, moreover comprising the triggering of an alarm following the detection of at least one previous startup having generated an error.

5. Method according to claim 4, moreover comprising a step to restore the default value of at least one parameter of the device when an alarm is triggered.

6. Method according to claim 4, moreover comprising a step to deactivate the launch of at least one module during the next device startup when an alarm is triggered.

7. Method according to claim 4, moreover comprising a step causing a download of a new version of resident software when an alarm is triggered.

8. Method according to claim 4, moreover comprising a step causing the display of information for the user when an alarm is triggered.

9. Electronic device comprising the permanent memory, a resident software designed to control it, resident software launch means upon startup of the device also comprising means to write information to the device memory before the launch of each module during the startup process that comprises the successive launch of a plurality of modules and means to detect an error arising during the previous startup according to the said information written to the memory during the startup process.

10. Device according to claim 9 moreover comprising means to delete the information written to the memory on completion of an error-free launch of at least one part of the resident software.

11. Device according to claim 9, moreover comprising means to trigger an alarm following the detection of at least one previous startup having generated an error.

12. Device according to claim 11, moreover comprising means to reset the default value of at least one parameter of the device when an alarm is triggered.

13. Device according to claim 11, moreover comprising means to deactivate the launch of at least one module during the next device startup when an alarm is triggered.

14. Device according to claim 11, moreover comprising means to cause a download of a new version of resident software when an alarm is triggered.

15. Device according to claim 11, moreover comprising means to display information for the user when an alarm is triggered.
